(19) United States
(12) Patent Application Publication
(10) Pub. No.: US 2007/0109809 A1
(43) Pub. Date: May 17, 2007

(54) BACKLIGHT MODULE

(75) Inventor: Guo-Han Yue, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,501

(22) Filed: Aug. 14, 2006

(30) Foreign Application Priority Data
Nov. 11, 2005 (TW) 094139699

(51) Int. Cl. F21V 7/04

(52) U.S. Cl. 362/613

(57) ABSTRACT

The backlight module includes a casing (21), a light guide plate (26) in the casing (21), a plurality of lamps (23A, 23B, 23C and 23D) arranged to illuminate the light guide plate, a plurality of image sensors (20A, 20B, 20C and 20D) configured for detecting illumination of corresponding lamps, a digital processor (30) configured for processing signals generated by the image sensors, and a plurality of lamp driving loops (32A, 32B, 32C and 32D) configured for receiving feedback signals generated by the digital processor and adjusting a lamp current voltage outputted by a lamp driving loop for each lamp, so as to get an uniform illumination of each lamp.

### FIELD OF THE INVENTION

The present invention generally relates to backlight modules, and, particularly, to a backlight module for a liquid crystal display (LCD) device.

### DISCUSSION OF THE RELATED ART

Most liquid crystal display (LCD) devices are passive devices in which images are displayed by controlling an amount of light inputted from an external light source. Thus, a separate light source (for example, backlight module) is generally employed for illuminating an LCD panel.

Generally, a backlight module should have good optical illumination and optical uniformity so as to improve the LCD devices' display effect, such as color contrast, optical brightness, and so on.

Referring to FIG. 1, a typical backlight module 10 is disposed below a LCD panel 16. The backlight module 10 includes a housing 11, a plurality of lamps 13 disposed in the housing 11 in a parallel manner, a diffusion sheet 14 disposed above the lamps 13, and an optical sheet 15 disposed above the diffusion sheet 14. The housing 11 is a plastic housing, and can also be replaced by a metallic casing. The diffusion sheet 14 is configured for uniformly diffusing the light emitted from the lamps 13, thus, a brightness of the LCD panel 14 would be more uniform. The diffusion sheet 14 is made of transparent resin materials such as polyester (PET) and polycarbonate (PC). The thickness of the diffusion sheet 14 ranges from 0.11 centimeters to 0.15 centimeters. The optical sheet 15 is configured for collimating the emitted light, thereby improving the brightness of light illumination. The optical sheet 15 is also made of transparent resin materials such as polyester (PET) and polycarbonate (PC).

Light emitted from the lamps 13 pass through the diffusion sheet 14 and the optical sheet 15, improving the optical brightness and optical uniformity of the LCD panel 16. However, the lamps are generally not completely identical due to differences developed during manufacturing process. If all of the lamps are driven by the same electric current or voltage, the lamps 13 will illuminate at different variations. Therefore, the optical brightness and optical uniformity of the backlight module 10 will be affected, and accordingly a desired display property of the LCD panel 16 will be reduced.

What is needed, therefore, is a backlight module which can improve the optical brightness and optical uniformity.

### SUMMARY

The present invention provides a backlight module. The backlight module includes a casing, a light guide plate disposed in the casing, a plurality of lamps arranged to illuminate the light guide plate, a plurality of image sensors configured for detecting illumination of corresponding lamps, a digital processor configured for processing signals generated by the image sensors, and a plurality of lamp driving loops configured for receiving feedback signals generated by the digital processor and adjusting a lamp current voltage outputted by a lamp driving loop for each lamp, so as to get an uniform illumination of each lamp.

Other advantages and novel features will become more apparent from the following detailed description of preferred embodiments when taken in conjunction with the accompanying drawings.

### BRIEF DESCRIPTION OF THE DRAWINGS

Many aspects of the backlight module can be better understood with reference to the following drawings. The components in the drawings are not necessarily drawn to scale, the emphasis instead being placed upon clearly illustrating the principles of the backlight module. Moreover, in the drawings, like reference numerals designate corresponding parts throughout the several views.

FIG. 1 is a schematic, cross-sectional view of a conventional backlight module;

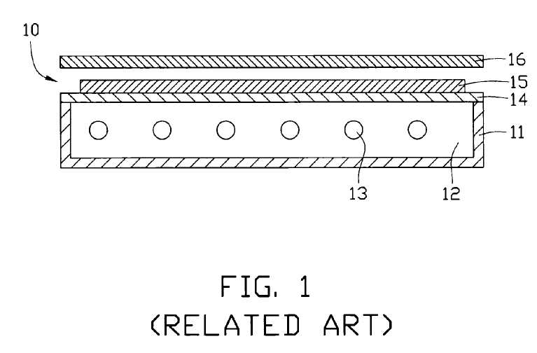

FIG. 2 is a schematic, isometric view of a backlight module according to a first embodiment;

FIG. 3 is a schematic, cross-sectional view taken along the line 111-111 of FIG. 2;

FIG. 4 is a partially isometric view of the backlight module without a casing and reflecting plate of FIG. 2;

FIG. 5 is a schematic, functional connecting chart of the backlight module of FIG. 2; and

FIG. 6 is a schematic, functional connecting chart of a backlight module according to a second embodiment.

### DETAILED DESCRIPTION OF THE EMBODIMENTS

Reference will now be made to the drawings to describe preferred embodiments of the present backlight module, in detail.

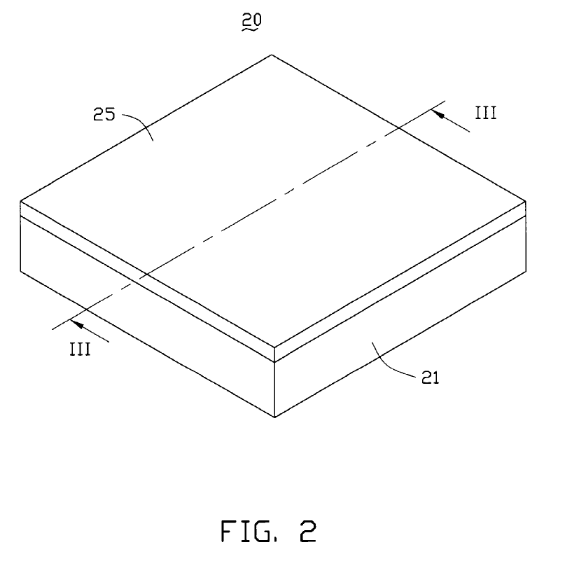

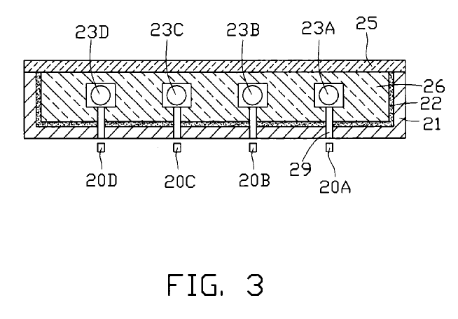

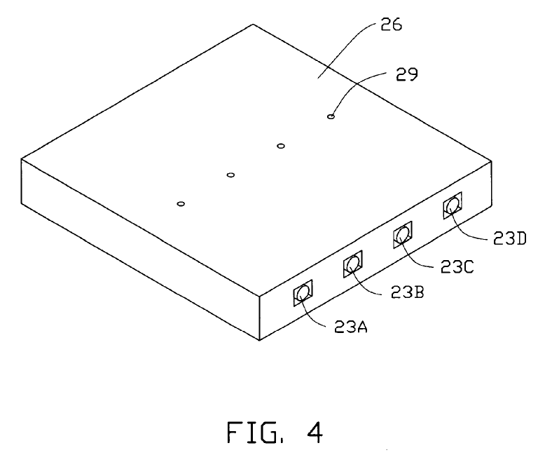

Referring to FIGS. 2 through 4, in a first preferred embodiment, a backlight module 20 includes a casing 21, a light guide plate 26 disposed in the casing 21, a reflecting plate 22, a plurality of lamps 23A, 23B, 23C, and 23D, at least one optical sheet 25, and a plurality of image sensors 20A, 20B, 20C, and 20D. The reflecting plate 22 is disposed between the casing 21 and the light guide plate 26. The lamps 23A, 23B, 23C, and 23D are disposed within the light guide plate 26, for example, the lamps 23A, 23B, 23C, and 23D are disposed in a plurality of receiving hole (not labeled) defined in the light guide plate 26. The receiving hole can also be replaced by a plurality of receiving channel defined in one side of the light guide plate 26. The at least one optical sheet 25 is disposed above the light guide plate 26. The image sensors 20A, 20B, 20C, and 20D are configured for detecting illumination of the corresponding lamps 23A, 23B, 23C, and 23D. The backlight module 20 defines a plurality of through holes 29 below the lamps 23A, 23B, 23C, and 23D; the through holes 29 are configured to run through the reflecting plate 22, the light guide plate 26, and the casing 21. Each of the through hole 29 corresponds to one of the lamps 23A, 23B, 23C, and 23D. The image sensors 20A, 20B, 20C, and 20D are disposed below the casing 21 and aims at the through holes 29 correspondingly.

The lamps 23A, 23B, 23C, and 23D are tubular fluorescent lamps, such as cold cathode fluorescent lamps (CCFLs). The total number of the lamps 23A, 23B, 23C, and 23D are also not limited to this embodiment, and the disposing manner for the lamps 23A, 23B, 23C, and 23D can also be in other manners, such as being disposed in the casing 21.

The optical sheet 25 is selected from one of a diffusing sheet, and a brightness enhancement sheet. The backlight module 20 may also include a plurality of optical sheets 25 according to the actual requirement.

The total number and the disposing manner of the image sensors 20A, 20B, 20C, and 20D corresponds to the total number and the disposing manner of the lamps 23A, 23B, 23C, and 23D so as to detect the illumination of the corresponding lamps 23A, 23B, 23C, and 23D. The image sensors 20A, 20B, 20C, and 20D may also be disposed at any positions in the backlight module 20, and at such positions the image sensors 20A, 20B, 20C, and 20D can effectively detect the illuminations of the lamps 23A, 23B, 23C, and 23D corresponding without interfering with the light emitted from the lamps 23A, 23B, 23C, and 23D. The image sensors 20A, 20B, 20C, and 20D can be selected from a group comprising of a photo diode, a charge couple device, a photoelectric crystal, a photosensitive resistance, and a combination thereof.

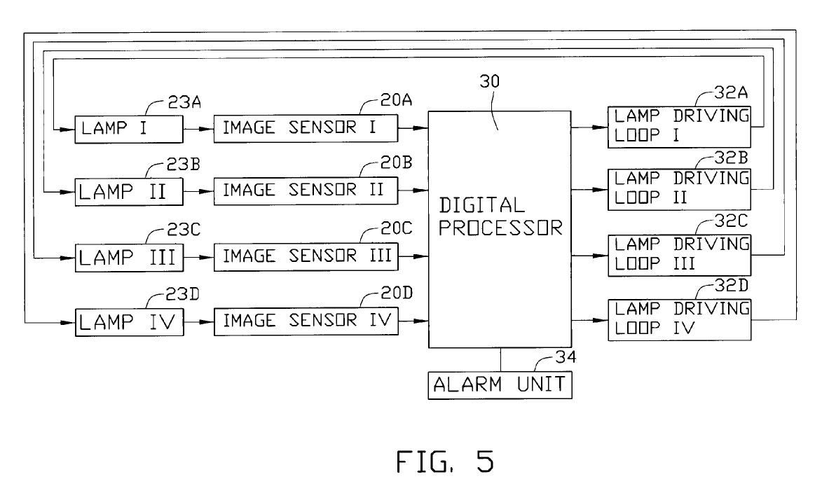

Referring to FIG. 5, the backlight module 20 further includes a digital processor 3 electrically connected to the image sensors 20A, 20B, 20C, and 20D, and a plurality of lamp driving loops 32A, 32B, 32C, and 32D electrically connecting with the lamps 23A, 23B, 23C, and 23D respectively. The digital processor 30 is configured for processing signals generated by the image sensors 20A, 20B, 20C, and 20D. The lamp driving loops 32A, 32B, 32C, and 32D are configured for receiving feedback signals generated by the digital processor 30 and adjusting a lamp current or voltage outputted by each driving loop 32A, 32B, 32C, and 32D for each of the lamps 23A, 23B, 23C, and 23D, thus each of the lamps 23A, 23B, 23C, and 23D illuminates uniformly.

When each of the lamps 23A, 23B, 23C, and 23D is driven by the lamp current or voltage outputted by each driving loop 32A, 32B, 32C, and 32D, each of the lamps 23A, 23B, 23C, and 23D are illuminated; each of the image sensors 20A, 20B, 20C, and 20D detects the illumination of each of the lamps 23A, 23B, 23C, and 23D and generates a corresponding signal. The signals generated by the image sensors 20A, 20B, 20C, and 20D are then sent to the digital processor 30. The signals are compared with a required average value, and then the digital processor 30 sends the corresponding feedback signals to the lamp driving loops 32A, 32B, 32C, and 32D. The lamp driving loops 32A, 32B, 32C, and 32D adjust the lamp current or voltage that drives each of the lamps 23A, 23B, 23C and 23D according to the corresponding feedback signals so that each of the lamps 23A, 23B, 23C, and 23D illuminates corresponding to the required average value.

The backlight module 20 further includes an alarm unit 34 connected with the digital processor 30. If one of the image sensors 20A, 20B, 20C, and 20D detects the corresponding illumination and generates a corresponding signal lower than the required average value and such corresponding signal continues over a certain time period, the alarm unit 34 will raise an alarm and further outputs a control signal so that the digital processor 30 cuts off the corresponding signal and the corresponding lamp driving loops 32A, 32B, 32C, and 32D turn off the lamps 23A, 23B, 23C, and 23D correspondingly.

The alarm raised by the backlight module 20 is one of a sound, a flash, and an image. The continuing time of the corresponding signal is selected according to an actual requirement.

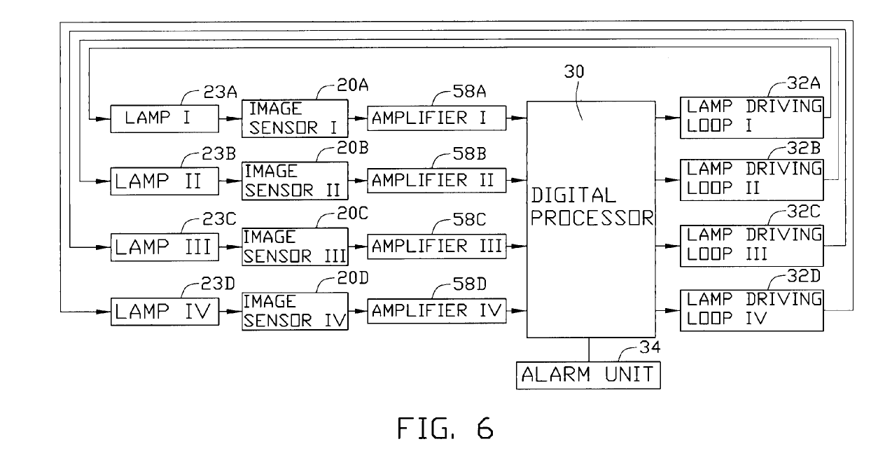

Referring to FIG. 6, in a second preferred embodiment, the backlight module (not shown) is substantially the same as the backlight module 20 in the first embodiment. The difference is that the backlight module has a plurality of amplifiers 58A, 58B, 58C, and 58D electrically connecting the image sensors 20A, 20B, 20C, and 20D to the digital processor 30. The amplifiers 58A, 58B, 58C, and 58D are configured for amplifying the signal generated by the image sensors 20A, 20B, 20C, and 20D according to an illumination of the lamps 23A, 23B, 23C and 23D. Therefore, the signal can be more accurately compared with the required average value so that the lamps 23A, 23B, 23C, and 23D can better controlled. The required average value is selected according to an actual requirement.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a casing;
a light guide plate disposed in the casing;
a plurality of lamps arranged to illuminate the light guide plate;
a plurality of image sensors configured for detecting illumination of corresponding lamps;
a digital processor configured for processing signals generated by the image sensors; and
a plurality of lamp driving loops configured for receiving feedback signals generated by the digital processor and adjusting a lamp current or voltage outputted by a lamp driving loop for each lamp, so as to get an uniform illumination of each lamp.

2. The backlight module according to claim 1, wherein a reflecting plate is disposed between the casing and the light guide plate.

3. The backlight module according to claim 1, wherein the image sensors are disposed at such positions where the image sensors can detect illuminations of the lamps corresponding without interfering with light emitted from the lamps.

4. The backlight module according to claim 1, wherein the lamps are disposed in the light guide plate, the backlight module defines a plurality of through holes below the lamps, the through holes run through the light guide plate and the casing, and each of the through holes corresponds to one of the lamps.

5. The backlight module according to claim 4, wherein each of the image sensors is disposed below the casing and aims at one of the through holes.

6. The backlight module according to claim 1, the backlight module further includes an alarm unit for raising an alarm and outputting a control signal so that the digital processor cuts off the corresponding signal and the corresponding lamp driving loops turn off the lamps correspondingly when one of the image sensors detects the corresponding illumination and generates a corresponding signal lower than a required average value and such corresponding signal continues over a certain time period.

7. The backlight module according to claim 6, wherein the backlight module further includes a plurality of amplifiers connecting the image sensors to the digital processor for amplifying the signal generated by the image sensors according to illumination of the lamps.

8. The backlight module according to claim 7, wherein the alarm raised by the backlight module is one of a sound, a flash and an image.

9. The backlight module according to claim 1, wherein the lamps are cold cathode fluorescent lamps.

10. The backlight module according to claim 1, wherein the image sensors are selected from a group comprising of a photo diode, a charge couple device, a photoelectric crystal, a photosensitive resistance and a combination thereof.

11. A backlight module comprising:
a light guide plate;
a plurality of light sources arranged to illuminate the light guide plate;
a plurality of image sensors positioned corresponding to the light sources and configured for detecting illumination of the corresponding light sources and generating signals associated with the illumination;
a digital processor electrically connected to the image sensors and configured for receiving the signals from the image sensors and generating adjusting signals for adjusting the illumination of the light sources to a predetermined degree; and
a plurality of lamp driving loops electrically connected between the digital processor and the light sources, and configured for adjusting a lamp current or voltage for each lamp in response to the adjusting signals in a manner so as to achieve a predetermined illumination degree of the light guide plate.

12. The backlight module according to claim 11, wherein the lamps are disposed in the light guide plate, the light guide plate defines a plurality of through holes below the lamps, the through holes run through the light guide plate, and each of the through holes corresponds to one of the lamps.

13. The backlight module according to claim 12, wherein each of the image sensors is disposed below the casing and aims at one of the through holes.

14. The backlight module according to claim 11, the backlight module further includes an alarm unit for raising an alarm and outputting a control signal so that the digital processor cuts off the corresponding signal and the corresponding lamp driving loops turn off the lamps correspondingly when one of the image sensors detects the corresponding illumination and generates a corresponding signal lower than a required average value and such corresponding signal continues over a certain time period.

15. The backlight module according to claim 14, wherein the backlight module further includes a plurality of amplifiers electrically connecting the image sensors to the digital processor for amplifying the signal generated by the image sensors according to illumination of the lamps.

16. The backlight module according to claim 15, wherein the alarm raised by the backlight module is one of a sound, a flash and an image.

17. The backlight module according to claim 11, wherein the lamps are cold cathode fluorescent lamps.

18. The backlight module according to claim 11, wherein the image sensors are selected from a group comprising of a photo diode, a charge couple device, a photoelectric crystal, a photosensitive resistance and a combination thereof.
